(19) United States
(12) Patent Application Publication
(10) Pub. No.: US 2021/0174350 A1
(43) Pub. Date: Jun. 10, 2021

(54) System to enable utilization and movement of digital assets without access to the private key for enabling complex operations

(71) Applicant: Allen Hena, Sewiclkey, PA (US)

(72) Inventor: Allen Hena, Sewiclkey, PA (US)

(21) Appl. No.: 16/731,315

(22) Filed: Dec. 31, 2019

Related U.S. Application Data
(60) Provisional application No. 62/945,240, filed on Dec. 9, 2019.

(51) Int. Cl. G06Q 20/36; H04L 9/08; G06Q 20/38; G06Q 20/06

(52) U.S. Cl. CPC G06Q 20/3678; H04L 9/0833; G06Q 2220/00; G06Q 20/065; G06Q 20/3829

(57) ABSTRACT

A system to enable change in state and/or configuration of digital assets without access to the private key for enabling complex operations includes one or more user computer based device and one or more server computer based device having an operably associated digital asset custody layer application engine, rules basket, protocol adapter and MPC/Self-Custody integration enabling complex actions or transaction to occur between user computer based device and server without surrendering private digital key access to a particular entity or individual.

### FIELD OF INVENTION

The subject matter herein generally relates to database-centered computer network systems and computer-implemented methods for cryptographically-secured digital asset data management.

### BACKGROUND OF INVENTION

Custody in the digital asset and cryptocurrency space is defined as full control of a private key which unlocks the ability for a user to commit transactions and a series of actions with that digital asset (digital assets as referred to herein will be inclusive of cryptocurrencies, utility tokens, non-fungible tokens, semi-fungible tokens, and security tokens). These digital assets are typically transferred over a computer network system which may include a group of computer systems and other computing hardware devices that are linked together through communication channels to facilitate communication and resource-sharing among a wide range of users.

As can be seen in the Prior Art FIGS. 1 and 2, upon receiving the digital asset transfer request, the state of the art application interface determines whether the request is for a digital asset transfer (simple action) only or more complex request. If more than just a simple digital asset transfer only transfer, no action is possible under current schemes and the request is denied. If the request is for a simple transfer (e.g., FIG. 2), then current technology utilizes a digital asset wallet module, and if necessary, keyshare storage module, to check multi-party computation (MPC)/self custody (SC) vendor for required approvals from other actors to take action corresponding to the transfer action request. Keyshare storage module is not necessary if keyshare is on the digital asset wallet. If approval is needed and given/obtained, action is taken and transfer is enabled. If it is not given, the flow is over and no action possible. The application interface sends transaction data to MPC/SC Vendor and obtains signed transaction content back from MPC/SC Vendor. The application interface uses a module to package transaction data with signed transaction portion and send transaction data to Networks. Further, the application interface uses a module to commit and confirm transaction data. The distributed ledger technology (DLT) is updated with the current value of the digital asset. Finally, the application interface uses a module to provide the targeted digital asset address showing a new balance in order to complete the action request.

There exist vendors in this space which enable self-custody of digital assets and cryptocurrencies via a technology called multi-party computation (MPC). These vendors deliver only self-custody based utilization for the movement of a digital asset from one location (e.g., an exchange) to another (e.g., a digital wallet). It is noted here that self-custody is implemented via MPC but all self-custody isn't enabled by MPC, there can be other ways to implement self-custody outside of an MPC mechanism. It is noted that the invention presented can also be utilized with a custodian entity, as the custodian has full control and access to a digital asset's private key.

### SUMMARY OF INVENTION

It is an object to enhance usage of digital assets.

It is a further object to provide a system for enhanced functional real-time or near-real time use of a digital assets while retaining custody of a private key but not having access to the private key. A digital asset as it relates to the invention can also be an operative mechanism (e.g. staking node, smart contract) which utilizes other digital assets and configurations for proper operation.

This invention focuses on building a flexible application and operative use case layer on top of self-custody and custodian solutions. The invention here is a system and method for interested parties (self-custody users) to enable movement of digital assets without access to the private key, leveraging or utilizing that digital asset for complex operations. The invention aims to enable complex and business specific operations of digital assets in a self-custody scenario. The invention aims to provide flexible and configurable applications (via application logic implemented by application objects) which allow for enforcement of mandatory minimum or maximum actors (i.e., those in a quorum), policies, validators and application specific modules to be defined, linked and setup in a way to support a complex series of events, functions and operations in the digital asset space in a self-custody scenario. The existing capabilities enabled by self-custody vendors (e.g. Unbound Technology) is limited to only moving digital assets from one endpoint (e.g. digital wallet) to another (e.g. exchange/wallet).

Accordingly, one aspect of the invention system is directed to include one or more user computer based device and one or more server computer based device having an operably associated digital asset custody layer application engine, rules basket, protocol adapter, and self-custody or custodian integrations enabling complex transactions and events to occur between the devices without surrendering private digital key access to a particular vendor or agent.

The user computer based device initiates an action request to digital asset custody layer application engine via an action request definition which is setup by the application objects module. The digital asset custody layer application engine (aka application engine) can include application objects module which support the following use cases, but not limited to, a DEX management module, staking pool management module, staking management module, and leveraging collateral module. These modules are specific to a business application or use-case and many other application or use-cases can be defined in the system. In addition the digital asset custody layer application engine includes actor-container management module, actor keyshare storage module (as necessary), external integrations module, common utility functions module and validation agents.

Upon receiving the action request, the digital asset custody layer application engine utilizes an application specific module to parse and process the action request based on application objects, external data and a rules basket. As necessary, actor keyshare storage module is used to enable checking MPC/SC vendor for required approvals from other actors to utilize keyshares and application object role pairing necessary to perform the outcome embodied by the action request. A keyshare storage module is only utilized if the keyshare is not stored on the user or server computer based device participating in the request or approval. In the event a custodian is used, the custodian would by its integration with the invention take the role of submitting all approvals and denials with full control of the private key. If approval is obtained, digital asset custody layer application engine responds to action request and utilizes application objects module to return command structures for the actor digital asset wallet to use to create action data. The actor digital asset wallet sends action data to protocol adapter for interested parties/self custody vendor and obtains required signed transaction content from MPC/SC Vendor or digital asset custodian to perform a series of action request commands which embody the outcome expected by the action request. The digital asset custody layer application engine or actor digital asset wallet uses a module to package the commands and sends the commands to network needed to execute the action request. The commands can contain signed transaction content from the self-custody vendor or digital asset custodian. In the event a digital asset custodian is used, the custodian sends signed transaction content within the system of the invention. Continuing, the digital asset custody layer application engine uses a module to commit and confirm commands to the networks, platforms or other external systems. Finally, the digital asset custody layer application engine uses a module to provide the targeted digital asset address showing a new state which could include a new balance but also a different state of an object acted upon via the application engine.

A system according to the invention which enables utilization and movement of digital assets without access to the private key for enabling complex operations over a Network includes:

one or more user computer based device which is operably connected to the Network having an application program requiring access through a user interface (UI) or API, authorization, authentication and registration by way of one or more user-specified operations to be applied to signals and/or states to be provided as operands for the one or more user-specified operations; and one or more server computer based device having an interface program residing on the computer based server which is operably connected to the Network, having an application program requiring access through a user interface (UI) or API, authorization, authentication and registration by way of one or more user-specified operations to be applied to signals and/or states to be provided as operands for the one or more user-specified operations and having an operably associated digital asset custody layer application engine module of the user interface program handling a signal request action by way of one or more user-specified operations to be applied to signals and having/or states to be provided as operands for the one or more user-specified operations including enabling at least one of a complex transaction and event to occur between the one or more user computer based device and the one or more server user device without surrendering private digital key access to a particular entity and whereupon obtaining authorization data the digital asset custody layer application engine module generates output command signals and/or states based at least in part on the authorization data.

Among those benefits and improvements disclosed, other objects and advantages of this disclosure will become apparent from the following description taken in conjunction with the accompanying figures. Detailed embodiments are disclosed however, it is to be understood that the disclosed embodiments are merely illustrative of the disclosure that may be embodied in various form the examples given in connection with the various embodiments of the present disclosure are intended to be illustrative, and not restrictive.

### BRIEF DESCRIPTION OF THE DRAWINGS

FIG. 1 depicts a flow chat of Prior Art for transferring a digital asset.

FIG. 2 is a diagram of Prior Art for a digital asset action.

FIG. 3 depicts a flow chart of an embodiment of the invention.

FIG. 4 is a diagram of a complex digital asset action of the invention.

FIG. 5 is a diagram of an aspect of the invention.

FIG. 6 is another diagram illustrating the system broadly in relation to its users.

FIG. 7 is a diagram more specifically outlining an embodiment of use of the invention.

FIG. 8 is a diagram outlining a custody application platform of the invention.

FIG. 9 is a diagram outlining make up of a command issued to DLT.

FIG. 10 is a diagram outlining an action request structure.

FIG. 11 is a diagram outlining integration difference between self custody vendor and digital asset custodian.

FIG. 12 is a diagram outlining key linkages in actor-container management module between keyshares and application object roles.

### DETAILED DESCRIPTION OF PREFERRED EMBODIMENTS

The following terms have the meanings explicitly associated herein, unless the context clearly dictates otherwise. The various embodiments of the disclosure may be readily combined, without departing from the scope or spirit of the disclosure. Terms such as “based on” is not exclusive and allows for being based on additional factors not described, unless the context clearly dictates otherwise, “a,” “an,” and “the” include plural references and “in” includes “in” and “on.”

Various aspects and functionality of the invention can be performed in real-time and/or dynamically. The term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process occurs (e.g., a user interacting with an application on a computer based device). The term “runtime” corresponds to any behavior that is dynamically determined during an execution of a software application or at least a portion of software application. The term “dynamically” means that events and/or actions can be triggered and/or occur without any human intervention.

The inventive electronic systems are associated with electronic devices (e.g., smartphones, etc.) of users and server(s) in the distributed network environment, communicating over a suitable data communication network (e.g., the Internet, etc.) and utilizing at least one suitable data communication protocol (e.g., IPX/SPX, X.25, AX.25, AppleTalk™, TCP/IP (e.g., HTTP), etc.). The inventive specially programmed computer based systems having associated devices are configured to operate in the distributed network environment, communicating over a suitable data communication network (e.g., the Internet, etc.) and utilizing at least one suitable data communication protocol (e.g., IPX/SPX, X.25, AX.25, AppleTalk™, TCP/IP (e.g., HTTP), etc.). It is noted that the invention can be implemented using any appropriate hardware and/or computing software languages and those of ordinary skill in the art are well versed in the type of computer hardware that may be used, the type of computer programming techniques that may be used (e.g., object oriented programming), and the type of computer programming languages that may be used (e.g., HTML (HyperText Markup Language), Go, Ruby/Ruby on Rails, C, C++, C#, Rust, Objective-C, Swift, Java, Javascript, Python, Perl, etc.).

The subject matter disclosed herein may be implemented in software or firmware or a combination of them or as instructions stored on a machine-readable medium, which may be read and executed by one or more processors. A machine-readable medium may include a medium and/or mechanism for storing or transmitting information in a form readable by a machine (e.g., a computing device). A machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), etc. A non-transitory computer readable medium does not include a transitory signal per se but may hold data temporarily in a “transitory” fashion such as RAM. A computer refers to a device having at least one software component and/or a combination of at least one software component and at least one hardware component which are designed/programmed/configured to manage/control other software and/or hardware components (such as the libraries, software development kits (SDKs), objects, etc.). Hardware can be processors (dual-core processor(s), dual-core mobile processor(s)), microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. One or more processors may be implemented as a Complex Instruction Set Computer (CISC) or Reduced Instruction Set Computer (RISC) processors; x86 instruction set compatible processors, multi-core, or any other microprocessor or central processing unit (CPU).

Software can include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Use of hardware elements and/or software is a function of desired computational rate, power levels, heat tolerances, processing cycle budget, input data rates, output data rates, memory resources, data bus speeds and other design or performance constraints. A multi-processor system may include a plurality of processor chips each of which includes at least one I/O component which is designed to directly connect to photonic components to connect to at least an I/O device. The I/O device can be a standard interface, such as peripheral component interconnect express (PCIe), universal serial bus (USB), Ethernet, Infiniband, and have include a storage device. A multi-processor system can include plurality of photonic components and an off-chip memory which may be shared by more than one of the processor chips and directly connected to a single processor chip and shared with other processor chips using a global memory architecture implemented by using a processor-to-processor approach. The multi-processor system may also include a cache and a plurality of processor chips each of which includes at least one I/O component which is designed to directly connect to the photonic components to communicate with one or more other processor chips. At least one I/O component of at least one of the processor chips may be configured to use a directory-based cache-coherence protocol. Cache of at least one of the processor chips may be configured to store directory information.

The off-chip memory may include a DRAM. In some embodiments and, optionally, in combination of any embodiment described above or below, directory information may be stored in the off-chip memory and the on-chip cache of at least one of the processor chips. The multi-processor system may further include a directory subsystem configured to separate the off-chip memory data and the directory information on to two different off-chip memories. The multi-processor system may include a directory subsystem configured with some of the subsystem implemented on a high-performance chip which is part of the 3D DRAM memory stack. In combination of any embodiment described above or below, the multi-processor system may further include a directory subsystem configured to support varying numbers of sharers per memory block. The multi-processor system may include a directory subsystem configured to support varying numbers of sharers per memory block using caching or include a directory subsystem configured to support varying numbers of sharers per memory block using hashing to entries with storage for different numbers of pointers to sharers. The multi-processor system may include a directory subsystem configured to use hashing to reduce storage allocated to memory blocks with zero sharers.

One or more aspects of may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

The inventive system may be based, at least in part, on Ethereum blockchain (Ethereum Foundation, Zug, Switzerland); on Hyperledger technologies, such as Hyperledger Fabric (The Linux Foundation, San Francisco, Calif.); Dash blockchain; Bitcoin blockchain; Tezos blockchain; on one or more DLT methodologies.

As used herein “action request” is a computer based device request made to the system which embodies a defined or configured operation specific to a stated use case or application. Examples of this include but are not limited to pooling of digital assets for an operation that only occurs when those combined digital assets reach a required threshold, an operation which enables a digital asset to be leveraged as collateral for the purposes of earning a yield or an operation which enables a digital asset to be leased by another actor for a stated amount of time.

As used herein “action data” is data needed by the System to properly orchestrate signed self-custody content and other commands needed to fulfill an action request.

As used herein “actor keyshare” is a keyshare which an actor (e.g. computer based device) holds securely on the device or has access to via a keyshare storage device provided by a 3rd party.

As used herein “agent” is a software or hardware program which runs on a computer based device which plays a supportive role in the application engine, rules basket and orchestration engine for the purposes of validating application rules, logic and actions requests.

As used herein “application object” is a component of the system which defines application or use-case specific business rules and workflows. This is accomplished via compiled or interpreted code which is used within the system and/or configurable settings stored in a database or file. An application object defines any role(s) it supports within the application or use-case for purpose of binding with keyshare(s).

As used herein “complex action” are single or multiple network commands specific to a defined application, business operation or use-case that an actor wishes to execute on a digital asset being self-custody.

A “command” is an executable call into a digital asset network, DLT or external network for the purposes of retrieving information, setting state or value changing transactions in a self-custody scenario.

The term “committed” refers to a network command which has been transmitted to the network in a manner that it is immutable as defined by that network.

The term “confirmed” refers to a network command which changes state of a digital asset and has been accepted by legitimate nodes supporting a DLT.

“Container” refers to a digital construct used by an MPC or self-custody system to distribute the contents of a private key into a keyshare to actors of a quorum.

“Custodian” or digital asset custodian refers to a business entity which offers a service or product to customers for storage of digital assets in a manner where the customer has no access to the digital asset's private key and the same business entity has full control of the digital asset being stored and will take action to transfer the digital asset at the behest of its customer.

“Custody” refers to access to the entire private key of a digital asset.

“DLT” is short for distributed ledger technology, wherein blockchains are an example of a DLT. Other examples include directed acyclic graph (DAG), hashgraph

“Digital asset” is an asset which is represented or rooted in a form that is electronic on a DLT. Digital assets are transferred electronically and secure via private key which enables full control of that digital asset. Cryptocurrencies (e.g. Bitcoin, Ethereum, non-fungible tokens, ERC-721) are all considered digital assets under this definition. A digital asset can also be an operative mechanism (e.g. staking node, smart contract) which utilizes other digital assets and configurations for proper operation.

“External data” is data which is created and sustained outside the system and DLT networks. An example of this includes but is not limited to digital asset exchanges, time data, application data, user inputs and oracles.

“Keyshare” is an encrypted or obfuscated portion of the private key of a digital asset which is produced from self custody/MPC vendors.

“MPC” refers to a method for interested parties to calculate an output while maintaining full privacy of their individual inputs which are required to derive the expected output.

“Network” refers to a collection of nodes or servers which track digital assets, often a DLT but not limited to a DLT, or the services and products built on top of a DLT to support utilization of that digital asset. Examples of these include but are not limited to Bitcoin, Litecoin, Ethereum, Compound. Finance, Tezzigator, etc.

“Oracle” is a third-party information/data source that has the sole function of supplying data to DLTs.

“Orchestration engine” refers to the automated configuration, coordination, and management of the system for the purposes of proper execution of network commands to execute action requests in a self-custody or MPC based operation. This orchestration is dependent on application objects, rules basket, self-custody/MPC vendor (or custodian) coordination and external data components.

“Pooling” refers to the activity of utilizing digital assets combined in a group to enable an activity only possible because of that combination

“Private key” is a secret key which gives you control of digital assets on a distributed ledger.

“Protocol adapter” is a component of the system responsible for configuration and building of the network commands which will be sent for execution on a network in a manner still supporting self-custody. This component is configurable or updatable via new compiled or interpreted computer code.

“Public key” is a public address in a distributed ledger technology (e.g. blockchain, directed acyclic graph), similar to an IP address or email address for an email account. Public key is linked to a digital asset's private key through cryptographic functions.

“Quorum” is a group of actors working in concert for the purpose of achieving a desired business outcome or action request outcome.

“Rules basket” in the context of during operation of the system, refers to the rules basket which sets the conditions under which a digital asset in a container can be utilized for a specified use case. This is determined by defined value thresholds, voting quorums and group hierarchies within the system.

“Self-custody” or “SC” refers to the ability for a system to hold a private key in a manner where key contents or parts never exists in the clear at any point of its life span. Keyshares are never combined at any point in time including but not limited to creation and use.

“Simple action” refers to a transfer of a digital asset from one wallet to another.

“Staking” is the activity of participating in consensus (agreement of state) operations of a DLT by holding or leveraging digital asset collateral which meet certain configuration requirements and volume thresholds.

“Transfer” refers to the action of committing a DLT transaction which features only sending a digital asset in part or whole to another wallet or container which supports the technology and protocol of the native digital asset in transit.

“Wallet” refers to a software and/or hardware construct which is designed and operated in a manner to support secure storage of the private key or keyshare of a digital asset.

In referring to the drawings, the system of the invention is generally depicted by the numeral 10. The system 10 includes one or more user computer based device 12 and one or more server computer used device 11 having an operably associated digital asset custody layer application engine 16 enabling complex transactions to occur without surrendering private digital key access to a particular entity.

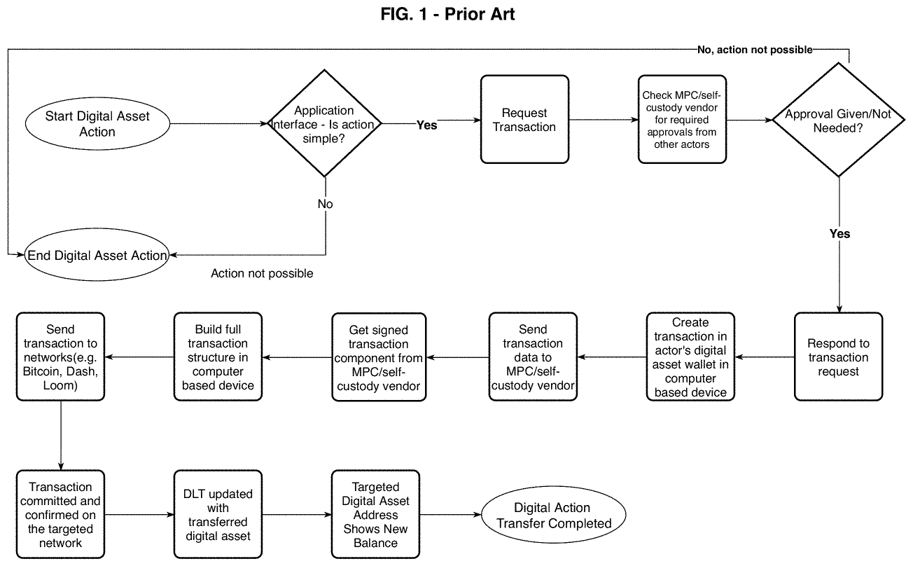

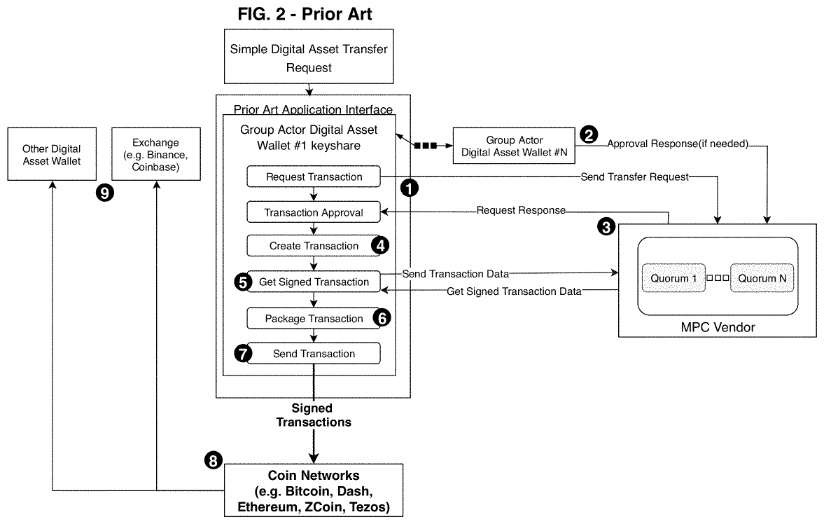

As discussed above, the Prior Art is generally represented in FIGS. 1 and 2. These outline the basic functionality of a transfer of a digital asset and current limitations. Here, a group actor is limited to the transfer of their digital asset through an application engine 16 which performs the functions to create, sign, package and send the transaction to a digital asset (e.g., coin) Network/Exchange.

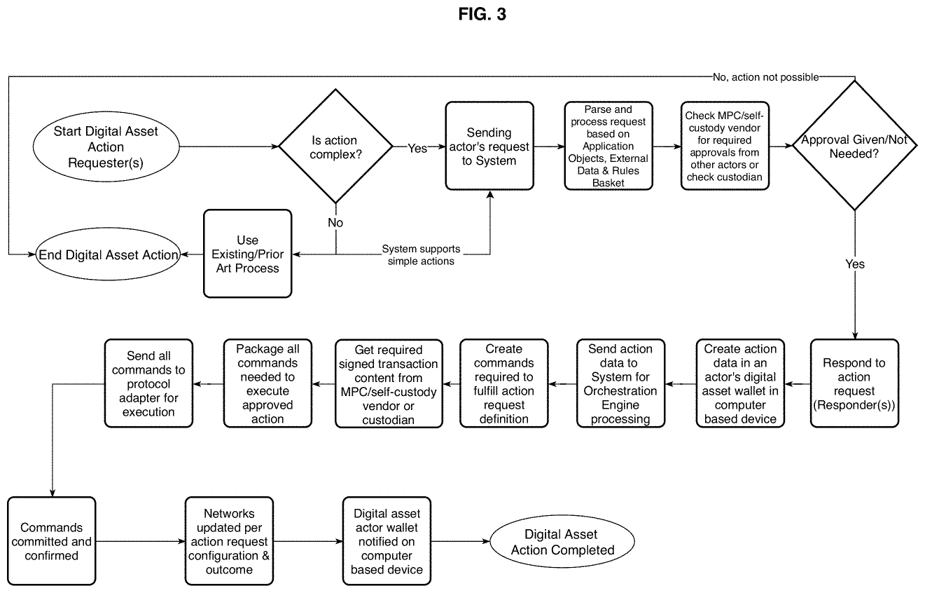

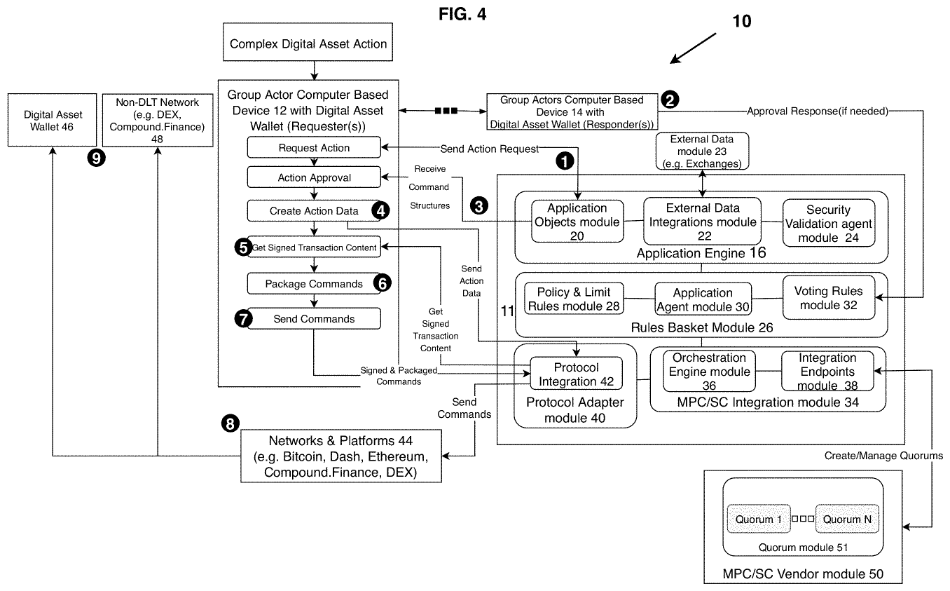

As seen in FIGS. 3-12, various aspects of the invention are provided. More specifically, there are exemplary embodiments outlining a complex digital asset action. There is provided a group actor digital asset wallet which initiates an action request. FIG. 3 provides for a flow chart for one envisioned embodiment. FIG. 4 outlines the components involved to perform the operations set forth in FIG. 3.

An aspect of the invention is directed to the system 10 according to the invention which enables utilization and movement of digital assets without access to the private key for enabling complex operations over a Network includes:

one or more user computer based device 12 which is operably connected to the Network 17 having an application program requiring access through a user interface (UI) or API, authorization, authentication and registration by way of one or more user-specified operations to be applied to signals and/or states to be provided as operands for the one or more user-specified operations; and

one or more server computer based device 11 having an interface program residing on the computer based server 11 which is operably connected to the Network 17, having an application program requiring access through a user interface (UI) or API, authorization, authentication and registration by way of one or more user-specified operations to be applied to signals and/or states to be provided as operands for the one or more user-specified operations and having an operably associated digital asset custody layer application engine module 16 of the user interface program handling a signal request action by way of one or more user-specified operations to be applied to signals and having/or states to be provided as operands for the one or more user-specified operations including enabling at least one of a complex transaction and event to occur between the one or more user computer based device 12/14 and the one or more server user device 11 without surrendering private digital key access to a particular entity and whereupon obtaining authorization data the digital asset custody layer application engine module generates output command signals and/or states based at least in part on the authorization data.

More particularly, in FIG. 4 there is a user, i.e., group actor computer based device 12 with a digital asset wallet which initiates an action request 1 to a digital asset custody layer application engine 16 using a non-custodial wallet ID and User Access. It is important to note that identifiers given here could be more or less as defined here depending on the use case or application being targeted by the action request. The digital asset custody layer application engine 16 (sometimes referred to as application engine 16) includes an application objects module 20, an external data integrations module 22 (associated with an external data module 23 (e.g. exchanges) and a security validation agent module 22. Operably associated with the digital asset custody layer application engine 16 is a rules basket module 26 which includes a policy and limits rules module 28, an application agent module 30, and a voting rules module 32.

Operably associated with the rules basket module 26 is an MPC/SC integration module 34 which includes an orchestration engine module 36 and an integration endpoints module 38. Operably associated with the MPC/SC integration module 34 is a protocol adapter module 40 having a protocol integration module 42 for handling commands to and from (command response) the digital asset custody layer application engine 16 to networks and platforms 44 which receive an updated state or value in a digital wallet 46 or non-DLT network 48.

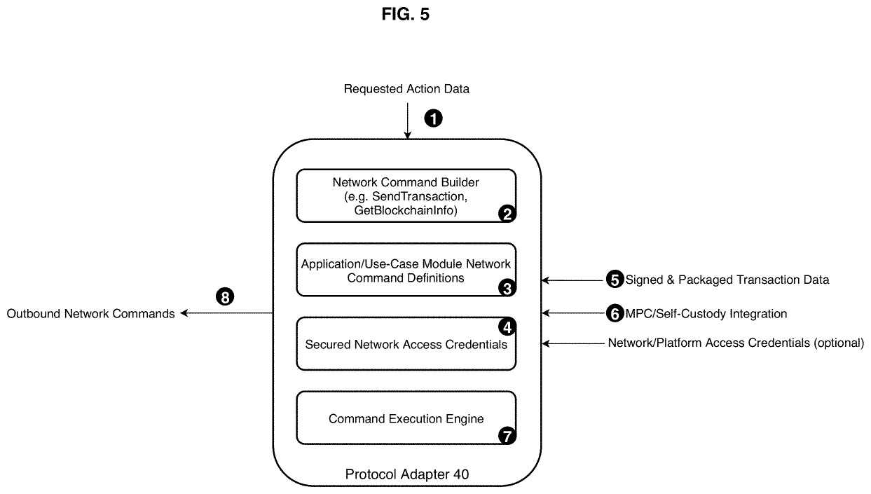

A group actor computer based device 14 operably communicates with the group actor computer based device 12 and the rules basket module 26. An MPC vendor module 50 includes one or more quorum(s) modules 51 which operably communicate with the MPC/SC integration module 34 to correctly translate container hierarchy and groupings. MPC Vendor module 50 can use quorums to manage group of actors for self-custody enablement. There can be implementations of self-custody utilizing other mechanisms (e.g. alternative to quorums for keyshare management) internally and also deliver the self-custody capability. The invention makes use of self-custody in any way it is provided by a self-custody/MPC vendor. The invention supports integration with a custodian with full control of the private keys to support aforementioned operations. FIG. 5 provides a simplified diagram of certain operations of the protocol adapter 40. The steps 1 to 8 outline these procedural functions in which the protocol adapter 40 performs commands.

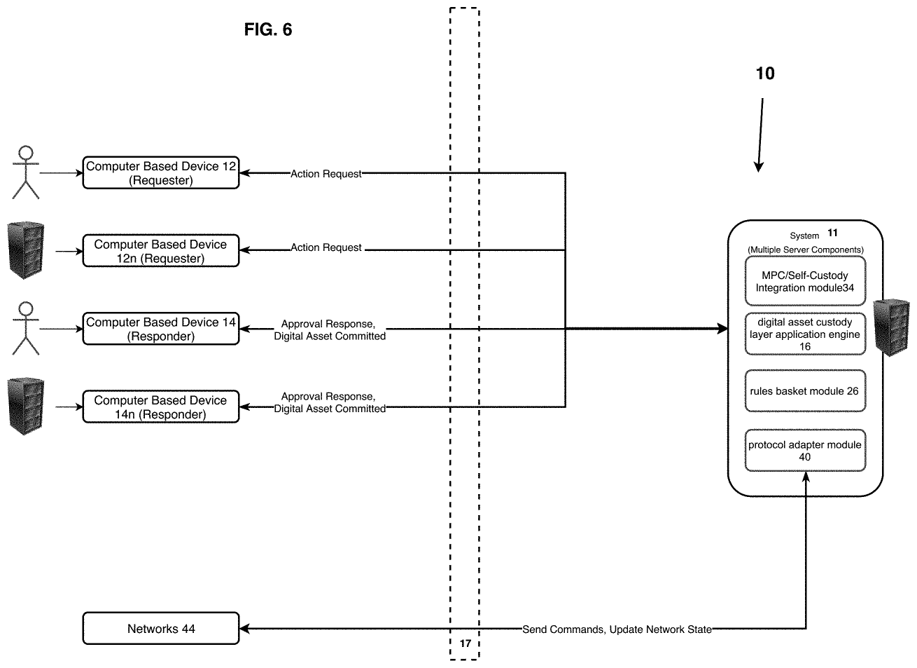

FIG. 6 depicts a broad perspective diagram of various user devices within the system 10 of the invention. Various user computer based devices 12, 12n, 14, 14n, for example, communicate over the network 17 to system server 11 under roles of requesters or responders, which includes, MPC/Self-Custody Integration module 34, application engine 16, rules basket module 26 and protocol adapter module 40 which collectively provide commands and update network status to networks 44.

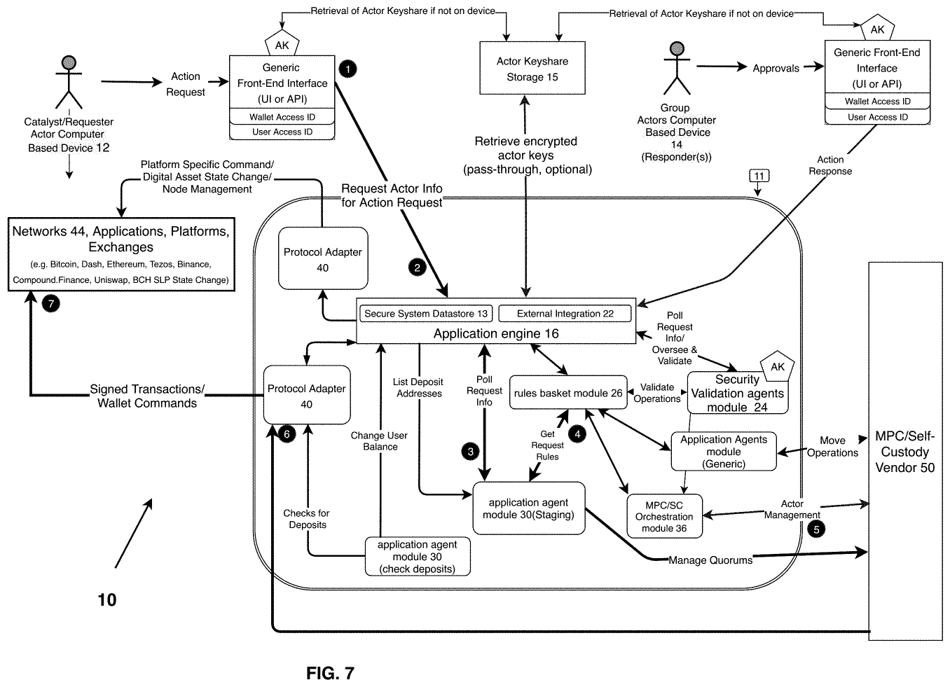

A detailed operational schematic is provided in FIG. 7. Here, actor computer based device 12 employs a generic front-end interface (with wallet access ID and User access ID used by application engine 16 which receives and stores the contents of the request in the secure system datastore 13, and retrieves encrypted actor keyshare from an optional actor keyshare storage database 15. Likewise, group actor computer based device 14 employs a generic front-end interface (with wallet access ID and User access ID) and initiates an action response, which embodies approval or disapproval with limits to an action request which the application engine 16 receives and stores the contents of the action request response in the secure system datastore 13, and retrieves encrypted actor keys from the actor key storage database 15. Security validation agent module 24 retrieves actor keyshare if not stored on agent and communicates the validation data and results to MPC/SC orchestration module 36.

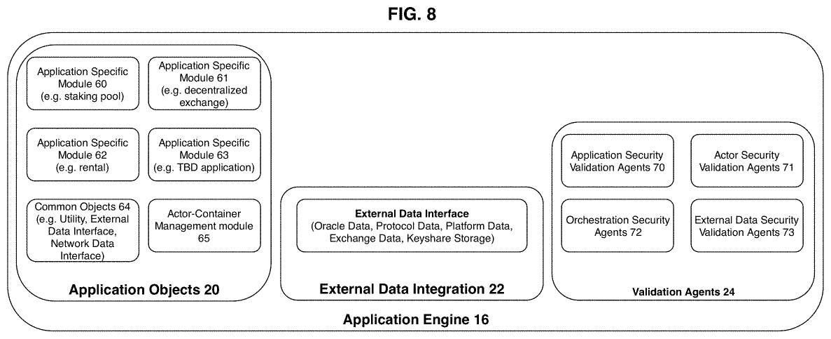

Rules basket module 26 employs and manages application agent module 30 to manage containers as defined in actor-container management module 65 and application specific modules 60-63 (FIG. 8). The policy and limit rules module 28 (FIG. 4) utilizes application specific modules 60-63 data to set values for application agent module 30 to verify condition for action request execution. Once the application agent module 30 have validated the conditions per policy and limit rules module 28 and voting rules module 32 for action request, commands are generated by the system 10 in a manner supportive of self-custody execution via protocol adapter 40 and MPC/Self-Custody integration module 34. A custodian in this scenario would be responsible for delivering any necessary signed content to the invention via integration endpoints 38. Network specific commands, digital asset state data change, node management, wallet commands and signed transactions are performed and transmitted to the networks or platforms 44.

As seen in FIG. 8 depicts certain important components of the application engine 16. The application engine 16 contains application specific modules which define the application or use case being supported by the system in a self-custody scenario. Application specific modules define action requests and necessary commands needed to support proper application operation in a self-custody scenario. Examples of these application specific modules include but are not limited to application specific module 60 for a staking pool operation, application specific module 61 for decentralized exchange operation in a self-custody scenario, application specific module 62 for rental or leasing of a digital asset in self-custody, application specific module 63 embodies yet to be defined application specific modules within the system 10. All application specific modules 60-63 utilize common objects 64 and the actor-container management 65 module. Each application specific module utilizes common objects 64 which can be used across any of the defined application specific modules. The common objects 64 allow operators of the system 10 to bring in external data from other platforms, protocols and exchanges for proper execution of the application or use case being supported by the system 10. The Actor-Container management module 65 enables the system to define keyshare and application object role bindings within the application specific modules 60-63 which map to roles defined within application specific modules 60-63 and define rules and configuration of validation agents 24. The Actor-Container management module 65 enables application specific modules to define quorum(s) hierarchy, keyshare and role mappings within a container to enable expected application execution. External Integration 22 component interfaces with data and information sources outside of the system critical to support operation of application specific modules 60-63. Validation Agents 24 perform validation of various states and data within the System 10. All Validation Agent module(s) 24 vary in number based on specification in application specific modules 60-63. Application security validation agent 70 is responsible for checking the system state specific to the application specific module for which rules it is checking. Actor security validation agent security validation agents 71 are responsible for verifying all actors within the system have authorized and proper access to the system. Orchestration security 72 is responsible for verifying containers and quorum structures are following all rules set forth in the application engine 16 and orchestration engine 36. External data security validation agents 73 are responsible for validation integrity or correctness of all external data which enters the System 10 in support of application objects module 20. The number of actors (e.g., 3 enables the lowest level of a possible 2 of 3 vote), note there could be more with there being a tie breaker. In other words, a M of N scenario, with M being the minimum threshold and N being the max number of possible votes. Validation agents broadly check the defined application objects and the data supplied to it and make sure the current conditions allow for a specific action to proceed or occur. Enough actors must agree per the configuration supplied for a specific action or step.

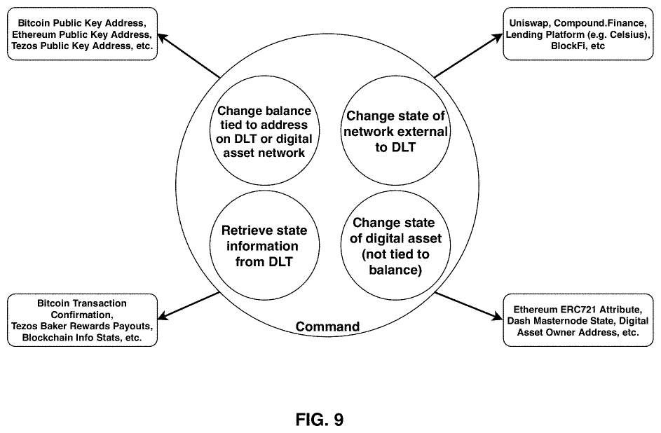

FIG. 9 depicts a command (by Protocol Adapter 40) which includes retrieving information from DLT or platform to check state, change balance tied to address on DLT or digital asset network, change state of network external to DLT or change state of digital asset (not tied to balance). These are types of commands performed to execute action requests in a self-custody scenario as defined and validated by application objects module 20.

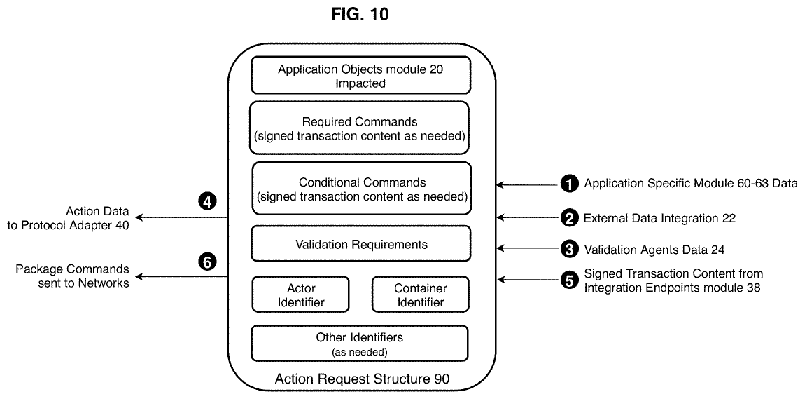

FIG. 10 depicts an action request structure 90 which is submitted by a user or agent on a computer based device 12, 14 and utilizes input from application engine 16 including application objects module 20 to define the required and conditional commands based on data from external data integration 22 and application specific modules 60-63. Validation requirements are also part of an action request structure 90 and in concert with validation agents data 24 identify the validity of the request and associated actors as defined by application specific modules 60-63. The Actor Identifier is a unique identifier to ensure the correct actor is identified. The container Identifier is a unique identifier specific to a container the action request to which it is associated. Other identifiers may be present which are needed to support the outcome of the action request. Action request structure 90 contains action data generated after receiving input from applications specific modules 60-63, external data integration data 22 and validation agents data 24. The action data is sent to protocol adapter 40. The action request is tracked via secure system data store 13 and is updated with required signed transaction content from Integration Endpoints module 38. This enables the action request structure to package network specific commands to be sent to networks 44 via protocol adapter 40 which may be done via user computer based device 12 or server based computer based device 11.

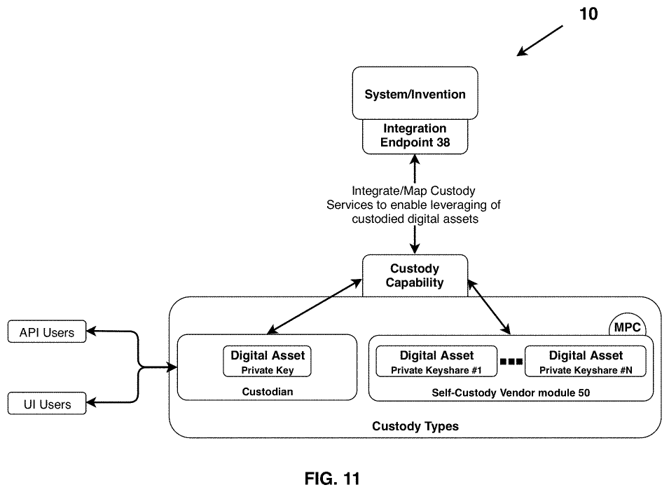

FIG. 11 depicts the interface and implementation variance between self-custody vendor and custodian for purposes of digital asset custody. Both types deliver a custody capability and thus can integrate and map services via Integration Endpoint 38 for the purpose of utilizing the invention.

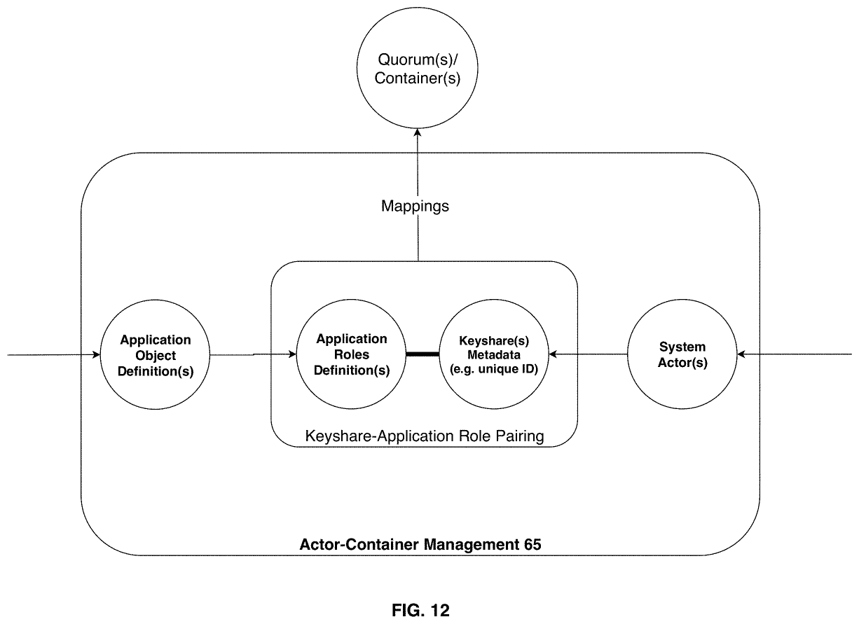

FIG. 12 depicts the binding design within the Actor-Container management module 65 which link the application roles defined within an application object to keyshare(s) associated with an actor or set of actors. Bindings produced map to quorums and/or containers which enable System 10 execution to Application Engine 16, Rules Basket 26 and integration to MPC/SC vendors via MPC/SC Integration module 34.

It will be appreciated that the above description relates to the preferred embodiments by way of example only. Many variations, derivations and improvements on the system and method will be apparent to those skilled in the art, and such variations derivations and improvements are within the scope of the invention as described and claimed, whether or not expressly described.

What is claimed is:

1. A system to enable utilization and movement of digital assets without access to the private key for enabling complex operations over a Network, which includes:
one or more user computer based device which is operably connected to the Network having an application program requiring access through one of a user interface (UI) and API, authorization, authentication and registration by way of one or more user-specified operations to be applied to signals and/or states to be provided as operands for the one or more user-specified operations; and
one or more server computer based device having an interface program residing on said computer based server which is operably connected to the Network, having an application program requiring access through a user interface (UI) or API, authorization, authentication and registration by way of one or more user-specified operations to be applied to signals and/or states to be provided as operands for the one or more user-specified operations and having an operably associated digital asset custody layer application engine module of said user interface program handling a signal request action by way of one or more user-specified operations to be applied to signals and having/or states to be provided as operands for the one or more user-specified operations including enabling at least one of a complex transaction and event to occur between said one or more user computer based device and said one or more server user device without surrendering private digital key access to a particular entity and whereupon obtaining authorization data said digital asset custody layer application engine module generates output command signals and/or states based at least in part on said authorization data.

2. The system of claim 1, wherein said user computer based device initiates a signal request action with said digital asset custody layer application engine via a non-custodial wallet ID and User Access ID.

3. The system of claim 1, wherein said digital asset custody layer application engine includes one of a DEX management module, a staking pool management module, a staking management module, a leveraging collateral module, a rental or lease management module, a defined use-case module, a utility functions module and validation agent module.

4. The system of claim 2, whereupon receiving said signal request action, said digital asset custody layer application engine utilizes a module to parse and process said request action based on application objects, external data and a rules basket.

5. The system of claim 2, whereupon receiving said signal request action, said digital asset custody layer application engine utilizes an actor keyshare storage module to check one of MPC/SC vendor and custodian for required approval from another computer based device which is operably connected to the Network having an application program requiring access through one of a user interface (UI) and API, authorization, authentication and registration by way of one or more user-specified operations to be applied to signals and/or states to be provided as operands for the one or more user-specified operations to utilize securely stored and application object role linked keyshare(s) corresponding to said action request.

6. The system of claim 5, whereupon receiving said approval is obtained, said digital asset custody layer application engine responds to signal request action and utilizes a wallet functions module to create action data in an actor digital asset wallet.

7. The system of claim 6, wherein said digital asset custody layer application engine sends transaction data to method for interested parties/self custody vendor and obtains signed transaction content from MPC/SC Vendor or custodian in a non-self custody scenario.

8. The system of claim 7, wherein said digital asset custody layer application engine uses a module to package command signals which embody request action and sends command signal to a Network.

9. The system of claim 8, wherein said digital asset custody layer application engine uses a module to commit and confirm command signals to a Network.

10. The system of claim 9, wherein one of a DLT network and non-DLT network is updated with confirmed digital asset data or updated state information.

11. The system of claim 10, wherein said digital asset custody layer application engine uses a module to provide a targeted digital asset address showing a new state which includes one of a new balance and a new state of an object acted upon in said digital asset custody layer application engine by value data checked and said rules basket.
